(19) United States
(12) Patent Application Publication
(10) Pub. No.: US 2006/0139027 A1
(43) Pub. Date: Jun. 29, 2006

(54) Spectroscopic imaging method, device comprising elements for carrying out said method and use of said imaging method for charctering materials

(76) Inventors: Wolfgang Dreher, Bremen (DE); Christian Geppert, Bremen (DE); Matthias Althaus, Bremen (DE)

Correspondence Address: SCHIFF HARDIN, LLP;PATENT DEPARTMENT, 6600 SEARS TOWER, CHICAGO, IL, 60606-6473, US

(21) Appl. No.: 10/527,382

(22) PCT Filed: Sep. 10, 2003
(86) PCT No.: PCT/DE03/02997

§ 371 Date: Oct. 17, 2005

(30) Foreign Application Priority Data
Sep. 13, 2002 (DE) 102 43830.7

(51) Int. Cl. G01V 3/00

(52) U.S. Cl. 324/307; 324/309

(57) ABSTRACT

In a spectroscopic magnetic resonance imaging method and apparatus, one or both of an SSFP-RF FID-like signal and an SSFP-RF echo-like signal are read out in one or two readout windows. The readout of this signal or these signals can take place with or without the presence of a magnetic field gradient.

The present invention relates to a Spectroscopic Imaging (SI) method using a Steady State Free Precession (SSFP)RF excitation pulse sequence, an apparatus for performing the same and the use of the imaging method for material characterization.

In the article “FAST 31P Chemical Shift Imaging Using SSFP Methods” by Oliver Speck, Klaus Scheffler and Jörgen Hennig, Proc. Intl. Soc. Mag. Reson. Med. 10 (2002) is described a spectroscopic imaging method using a SSFP-RF excitation pulse sequence for phosphorus. As in the imaging method described therein a signal is evaluated and results from a superimposing of the Free Induction Decay (FID)-like signal S1 and the SSFP echo S2 (also called echo-like signal), in a single measuring pass only signals in a very small frequency range can be evaluated. It is disadvantageous that the minimum measuring time for several signals rises and that the Signal-to-Noise Ratio (SNR) per standard measurement time falls, because the measurements can only take place sequentially and not simultaneously.

Therefore the problem of the invention is to provide a spectroscopic imaging method of the aforementioned type and an apparatus for performing the same by means of which shorter minimum measurement times can be implemented.

According to the invention, this problem is solved in a first aspect by a spectroscopic imaging method using a SSFP-RF excitation pulse sequence with the following features: with a repetition time or time repetition (TR) RF excitation pulses with a flip angle are irradiated onto a test object, between the RF excitation pulses in a first readout window and without the presence of a magnetic field gradient a FID-like SSFP signal S1 and in a second readout window separate from the first readout window and without the presence of a magnetic field gradient an echo-like SSFP signal S2 is read out, before the first readout window at least one phase coding gradient is switched for phase coding in at least one spatial direction and before the next RF excitation pulse at least one phase coding gradient is switched for cancelling out a phase coding in at least one spatial direction. The phase coding gradient or gradients are used for spatial coding or spatial resolution.

This problem is solved according to a second aspect by a spectroscopic imaging method using a SSFP-RF excitation pulse sequence having the following features: with a repetition time (TR) RF excitation pulses with a flip angle are irradiated onto a test object, between the RF excitation pulses in a single readout window and without the presence of a magnetic field gradient only one FID-like SSFP signal S1 is read out, before the readout window at least one phase coding gradient is switched for phase coding in at least one spatial direction and before the next RF excitation pulse at least one phase coding gradient is switched for cancelling out the phase coding.

This problem is also solved according to a third aspect by a spectroscopic imaging method using a SSFP RF excitation pulse sequence with the following features: with a repetition time (TR) RF excitation pulses with a flip angle are irradiated onto a test object, between the RF excitation pulses in a single readout window and without the presence of a magnetic field gradient only one echo-like SSFP signal S2 is read out, before the readout window at least one phase coding gradient is switched for phase coding in at least one spatial direction and before the next RF excitation pulse at least one phase coding gradient is switched for cancelling out the phase coding.

According to a fourth aspect this problem is also solved by a spectroscopic imaging method using a SSFP RF excitation pulse sequence having the following features: with a repetition time (TR) RF excitation pulses with a flip angle are irradiated onto a test object and between the RF excitation pulses in a first readout window under at least one readout gradient oscillating in one spatial direction a FID-like SSFP signal S1 and in a second readout window separate from the first readout window and under at least one readout gradient oscillating in one spatial direction an echo-like SSFP signal S2 is read out. The oscillating readout gradient or gradients are used for spatial coding or spatial resolution.

According to a fifth aspect of the invention, this problem is also solved by a spectroscopic imaging method using a SSFP RF excitation pulse sequence having the following features: with a repetition time (TR) RF excitation pulses with a flip angle are irradiated onto a test object and between the RF excitation pulses, in a single readout window under at least one readout gradient oscillating in one spatial direction only one FID-like SSFP signal S1 is read out.

According to a sixth aspect, this problem is also solved in a spectroscopic imaging method using a SSFP RF excitation pulse sequence with the following features: with a repetition time (TR) RF excitation pulses with a flip angle are irradiated onto a test object and between the RF excitation pulses, in a single readout window and under at least one readout gradient oscillating in one direction a single echo-like SSFP signal S2 is read out.

This problem is also solved by an apparatus having means for performing the method according to one of the claims 1 to 49.

In the imaging method according to the first aspect, the separation of the first and second readout windows advantageously takes place by switching a first spoiler gradient between the FID-like SSFP signal S1 and the echo-like SSFP signal S2.

It is also possible for the RF excitation pulses to be irradiated in layer-selective manner. This is e.g. possible through the irradiation of the RF excitation pulses with a simultaneously switched layer selection gradient. The spatial, layer-selective irradiation of the RF excitation pulses is used for spatial coding or spatial resolution.

Advantageously a second spoiler gradient is switched between the FID-like SSFP signal S1 and the echo-like SSFP signal S2 and between the first and second spoiler gradients is irradiated a frequency-selective saturation pulse for suppressing an interfering signal. The interfering signal can in general terms be the signal of a dominant solvent, e.g. water.

Advantageously after the first readout window and before the second readout window successively at least one phase coding gradient is switched for cancelling out the phase coding in at least one spatial direction and at least one phase coding gradient for phase coding in at least one spatial direction.

In an alternative embodiment of the invention, the RF excitation pulses are frequency-selective. Advantageously the RF excitation pulses are frequency-selective in such a way that in general an interfering, dominant signal, such as e.g. a water signal, is not or is only slightly excited and/or is not or is only slightly refocussed. Such a frequency-selective excitation and/or refocussing can in particular take place by amplitude-modulated and/or frequency-modulated RF pulses or by groups of hard RF excitation pulses.

Advantageously, in the imaging method according to the second aspect, a spoiler gradient is switched following the readout window.

It can in particular be provided that the RF excitation pulses are irradiated in layer-selective manner.

According to a further, special embodiment of the invention, a second spoiler gradient can be switched following the readout window and between the first and second spoiler gradients is irradiated a frequency-selective saturation pulse for suppressing an interfering signal.

Alternatively the RF excitation pulses can be frequency-selective.

In the imaging method according to the third aspect a first spoiler gradient can be switched before the readout window.

In particular, the RF excitation pulses can be irradiated in layer-selective manner.

Advantageously, before the readout window a second spoiler gradient is switched and between the first and second spoiler gradients a frequency-selective saturation pulse is irradiated for suppressing an interfering signal.

Alternatively the RF excitation pulses can be frequency-selective.

In the imaging method according to the first aspect, before the first readout window can be switched precisely two phase coding gradients for the phase coding in two spatial directions and before the next RF excitation pulse can be switched precisely two phase coding gradients for cancelling out a phase coding in the two spatial directions. This provides a two-dimensional resolution within a selected layer.

It is also possible to switch precisely three phase coding gradients for phase coding in three spatial directions before the first readout window and precisely three phase coding gradients for cancelling out a phase coding in the three spatial directions before the next RF excitation pulse. This provides a three-dimensional resolution in the selected layer.

In the imaging method according to the first aspect, following the first readout window and before the second readout window successively precisely two phase coding gradients are switched for cancelling out the phase coding in two spatial directions and precisely two phase coding gradients for phase coding in two spatial directions.

It is also possible after the first readout window and before the second readout window to successively switch precisely three phase coding gradients for cancelling out the phase coding in three spatial directions and precisely three phase coding gradients for phase coding in three spatial directions.

In the imaging method according to the second aspect before the readout window can be switched precisely two phase coding gradients in two spatial directions and before the next RF excitation pulse precisely two phase coding gradients for cancelling out a phase coding in the two spatial directions.

It is also possible before the readout window to switch precisely three phase coding gradients for phase coding in three spatial directions and before the next RF excitation pulse precisely three phase coding gradients for cancelling out a phase coding in the three spatial directions.

In the imaging method according to the fourth aspect the FID-like SSFP signal s1 and the echo-like SSFP signal S2 can in each case be read out under precisely one oscillating readout gradient, before the first readout window one or two phase gradients can be switched for phase coding in one or two spatial directions and before the next RF excitation pulse one or two phase coding gradients can be switched for cancelling out a phase coding in one or two spatial directions. As the oscillating readout gradient already provides a resolution in one dimension within a selected layer, a phase gradient contributes to the resolution in the second dimension and a further phase gradient to the resolution in the third dimension.

According to a special embodiment of the invention the FID-like SSFP signal S1 and the echo-like SSFP signal S2 can be read out under precisely two readout gradients oscillating in different spatial directions and before the first readout window is switched precisely one phase coding gradient for phase coding in one spatial direction and before the next RF excitation pulse can be switched precisely one phase coding gradient for cancelling out a phase coding in the spatial direction.

The FID-like SSFP signal S1 and the echo-like SSFP signal S2 can in each case be read out under precisely three readout gradients oscillating in different spatial directions.

Advantageously the separation of the first and second readout windows takes place by switching a first spoiler gradient between the FID-like SSFP signal S1 and the echo-like SSFP signal S2.

It is also possible for the RF excitation pulses to be irradiated in layer-selective manner.

Advantageously a second spoiler gradient is switched between the FID-like SSFP signal S1 and the echo-like SSFP signal S2 and between the first and second spoiler gradients is irradiated a frequency-selective saturation pulse for suppressing an interfering signal.

Advantageously after the first readout window and before the second readout window successively switching takes place of at least one phase coding gradient for cancelling out the phase coding in at least one spatial direction and at least one phase coding gradient for phase coding in at least one spatial direction.

According to an alternative embodiment of the invention the RF excitation pulses are frequency-selective.

In the imaging method according to the fifth aspect of the invention advantageously the FID-like SSFP signal S1 is read out under precisely one readout gradient oscillating in one spatial direction, before the readout window one or two phase gradients are switched for phase coding in one or two spatial directions and before the next RF excitation pulse one or two phase coding gradients are switched for cancelling out a phase coding in one or two spatial directions.

It is in particular possible that the FID-like SSFP signal S1 is read out under precisely two readout gradients oscillating in different spatial directions and before the readout window is switched precisely one phase coding gradient for phase coding in one spatial direction and before the next RF excitation pulse is switched precisely one phase coding gradient for cancelling out a phase coding in the spatial direction.

It is also possible for the FID-like SSFP signal S1 to be read out under precisely three readout gradients oscillating in different spatial directions.

Advantageously a first spoiler gradient is switched after the readout window.

It is also possible for the RF excitation pulses to be irradiated in layer-selective manner.

Advantageously after the readout window is switched a second spoiler gradient and between the first and second spoiler gradients a frequency-selective saturation pulse is irradiated for suppressing a first interference signal.

In an alternative embodiment the RF excitation pulses are frequency selective.

In the imaging method according to the sixth aspect of the invention the echo-like SSFP signal S2 is read out under precisely one readout gradient oscillating in one spatial direction, before the readout window one or two phase gradients are switched for phase coding in one or two spatial directions and before the next RF excitation pulse one or two phase coding gradients are switched for cancelling out a phase coding in one or two spatial directions.

According to another special embodiment of the invention the echo-like SSFP signal S2 is read out under precisely two readout gradients oscillating in different spatial directions and before the readout window is switched precisely one phase coding gradient for phase coding in one spatial direction and before the next RF excitation pulse is switched precisely one phase coding gradient for cancelling out a phase coding in the spatial direction.

The echo-like SSFP signal S2 can be read out under precisely three readout gradients oscillating in different spatial directions.

Advantageously following the readout window is switched a first spoiler gradient.

The RF excitation pulses can also be irradiated in layer-selective manner.

Advantageously following the readout gradient is switched a second spoiler gradient and between the first and second spoiler gradients a frequency-selective saturation pulse is irradiated for suppressing an interference signal.

In an alternative embodiment the RF excitation pulses can be frequency-selective.

It is also possible for the signals S1 and/or S2 to be detected with a single RF coil.

Alternatively the signals S1 and/or S2 can be detected with at least two RF coils with spatially different sensitivity profiles. Parallel signals are detected in each RF coil. As a result the number of necessary phase coding steps can be reduced for a clearly defined voxel size and voxel number (parallel imaging). For details of this reference should be made to K. Pruessmann, M. Weiger, M. B. Scheidegger, P. Boesiger, “SENSE: Sensitivity encoding for fast MRI”, Magn. Reson. Med. 42, 952-962 (1999), whose content is hereby incorporated by reference.

The apparatus can be a magnetic resonance apparatus, particularly a nuclear spin tomography apparatus or a nuclear spin spectroscopy apparatus or a combination thereof.

The use of a method according to one of the claims 1 to 49 for material characterization is also proposed.

Finally, the use of a method according to one of the claims 1 to 49 for the characterization of ageing processes is proposed.

The invention is based on the surprising finding that with the spectroscopic imaging methods according to the invention the advantages attainable when using SSFP sequences in Magnetic Resonance Imaging (MRI), such as in particular low minimum measurement times (i.e. the time necessary in order to record a complete data set) and high SNR can also be obtained. The minimum measurement times are particularly short if the signals are read out under an oscillating readout gradient. These are well below the total measurement times of the pulse sequences presently available on clinical nuclear spin, graphic equipment. It is also possible to conceive a much more extensive use of the inventive spectroscopic imaging methods on clinical and/or other (e.g. smaller systems for animal experiments, material testing, etc.) nuclear spin tomographic equipment.

The spectroscopic imaging methods according to the invention make only minor demands on the hardware (magnetic field (B0) gradients, RF power, etc.) and can be favourably scaled if the measurements take place at higher magnetic field strengths. The use of higher magnetic fields is a major trend for clinical or other uses of nuclear spin tomography/spectroscopy.

Further advantages of the spectroscopic imaging methods according to the invention are:

SNR Per Standard Measurement Time (SNRt).

The SNRt can be higher than in other hitherto known spectroscopic imaging methods for uncoupled signals. There is also a possible optimization for J-coupled signals (repetition time TR as a function of T2 (spin-spin relaxation time) and J-coupling.

Spatial Resolution.

If phase coding gradients are used for the phase coding of spatial information, losses in the spatial resolution are avoided which are caused by the signal drop with T2 or T2* (effective transverse relaxation time), such as e.g. occurs in sequences based on U-FLARE or RARE (Rapid Acquisition with Relaxation Enhancement). The reduction of the spatial resolution is virtually negligible when using an oscillating readout gradient.

The exclusive reading out of the FID signal S1 in particular also permits a detection of signals having a short T2 and which therefore do not or with only a limited intensity contribute to the echo-like SSFP signal S2. As a result of the low T2, the SNR is higher than for the echo-like SSFP signal S2. In addition, the start of detection of S1 takes place only just after signal excitation (typically a few ms), because the phase modulation of J-coupled signals, which in particular lead to signal losses with respect to multiplet signals, is very limited.

The exclusive reading out of the SSFP signal S2 more particularly permits the detection of signals with a longer T2, but not signals with a shorter T2. It is possible to detect singlet signals (without J-coupling), as well as J-coupled signals, the spacing of the RF excitation pulses strongly influencing their intensity. Thus, as a function of the spacing of the RF excitation pulses, it is possible to both detect and also deliberately suppress J-coupled signals with a good SNR (in order e.g. to avoid superimposing with another signal). The easier and stronger suppression of interfering signals (e.g. water and lipid signals in the ¹H-NMR) is particularly advantageous. This can be brought about not only by the different T2 influence, but also by the use of frequency-selective RF excitation pulses, because both the frequency-selective excitation and the (once or several times) frequency-selective refocussing of the signal brings about a better suppression of the interfering signals.

Through the reading out of both signals S1 and S2 in adjacent readout windows, the advantages of spectroscopic imaging methods with exclusive reading out of the particular S1 and S2 can be utilized, but this leads to the disadvantage that for a given repetition time of the RF excitation pulses for the reading out of each individual S1 and S2 there is less readout time compared with the situation with exclusive readout. The repetition time TR can also be optimized in such a way that there can be an evaluation of the measurements times either in the frequency range (reconstruction e.g. by Fourier transformation) after using specific apodization functions (data preprocessing) and/or with the aid of methods for the data extrapolation of the measurement time signal or by analysis in the time range (adaptation of model functions). There is both an adequate spectral resolution and an adequate SNR. The optimum repetition time TR is dependent on T1 (spin-lattice relaxation time), T2, T2* and the necessary or desired width and resolution of the spectrum. Specifically the detection of the signals of J-coupled spins can be optimized in that the repetition time TR is also chosen as a function of the multiplet structure and the J-coupling constants.

If in a special embodiment of the inventive spectroscopic imaging methods in general an interfering dominant signal (D1, D2), such as e.g. a water signal, is suppressed, this permits the use in proton spectroscopy (1H)-SI, which is at present the greatest partial field for SI in connection with clinical applications.

Further features and advantages of the invention can be gathered from the claims and the following description of several embodiments and with reference to the attached diagrammatic drawings, wherein show:

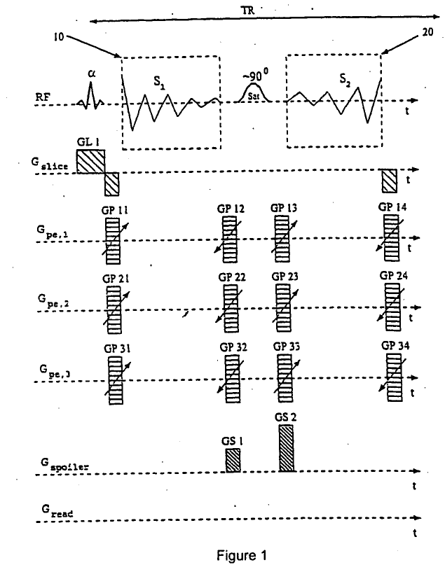

FIGS. 1 to 7 Excitation pulse and gradient diagrams or graphs together with signals of spectroscopic imaging methods according to special embodiments of the present invention.

FIG. 8 Examples of the measurement results obtained with a spectroscopic imaging method according to a special embodiment of the present invention.

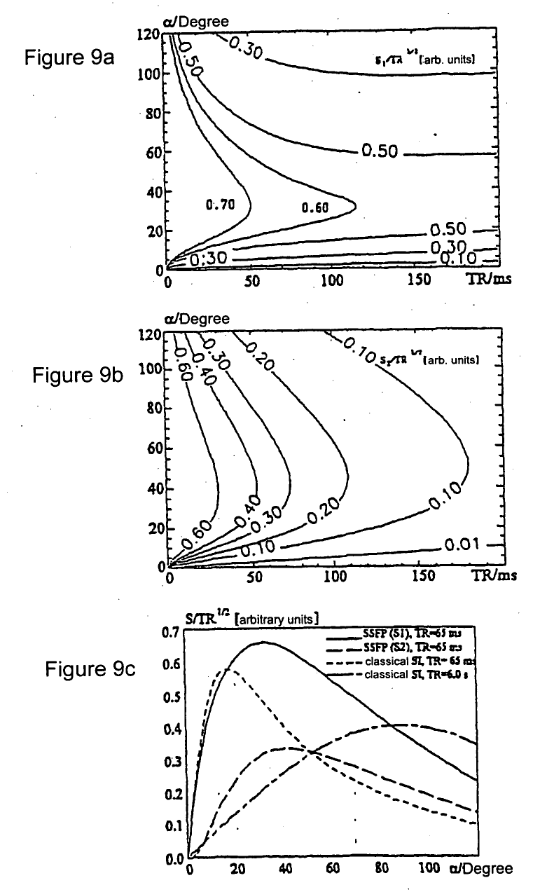

FIG. 9 Results of computer simulations of signal-to-noise ratios (SNRt) per standard measurement time obtainable by means of SSFP-based spectroscopic imaging and spectroscopic imaging according to the prior art.

Before reference is made to the individual drawings, it is necessary to assume that the excitation pulse and gradient graphs are intended to be understood diagrammatically and are in particular not to scale. In addition, some successive gradients can be simultaneously used, but this has been avoided here so as not to make understanding and reading more difficult. In each case seven traces (RF (RF excitation pulses and signal(s)), Gpe,1, Gpe,2, Gpe,3, Gspoiler, Gslice, Gread), although some are not used. In practice, the six gradient traces are superimposed on the three physical gradients (Gx, Gy, Gz).

Moreover, the use of a third phase coding gradient is optional when using a layer-selective RF excitation pulse.

The spatial directions for the phase coding, layer selection and readout gradients should preferably be pairwise orthogonal, although this is not prescribed. The spoiler gradients can be at a different angle thereto, because they can arise through the summation of several gradients (x, y, z).

Finally, each of the broken line boxes indicates a readout window.

The excitation pulse and gradient graph of FIG. 1 illustrates a spectroscopic imaging method according to a special embodiment of the present invention which is based on a Fast Acquisition Double Echo (FADE) (for details reference is made to “FADE—A New Fast Imaging Sequence”, T. W. Redpath, R. A. Jones, Magnetic Resonance in Medicine 6, pp 224 to 234, 1988)-SSFP sequence. By irradiating a RF excitation pulse with a flip angle under a layer selection gradient GL1 onto a test object a layer-selective excitation takes place.

For three-dimensional spatial resolution in a selected layer, before a first readout window 10 the phase coding gradients GP11, GP21 and GP31 are switched and after a second readout window 20 by means of the phase coding gradients GP14, GP24 and GP34 the phase coding is cancelled out.

Due to the absence of a magnetic field gradient during the reading out of the FID signal S1 and the SSFP signal S2, apart from the spatial signal distribution, also the information on the chemical shift (spectral distribution) is determined.

The separation of the first and second readout windows 10 and 20 takes place by switching a first spoiler gradient GS1 between the FID-like SSFP signal S1 and the echo-like SSFP signal S2. In addition, a second spoiler gradient GS2 is switched between the FID-like SSFP signal S1 and the SSFP echo S2 and between the first and second spoiler gradients GS1 and GS2 is irradiated a frequency-selective saturation pulse Sat for suppressing an interfering signal, here a water signal.

For security purposes, following the first readout window the phase codings by GP11, GP21 and GP31 are cancelled out by switching the phase coding gradients GP12, GP22 and GP32 and before the second readout window further phase codings take place by switching the phase coding gradients GP13, GP23 and GP33.

The repetition times TR typical for the magnetic field strength of B0=4.7 T used here for measurement on phantoms (model solutions) or on a rat brain are in the range 60 to 120 ms. The saturation pulse Sat has a length of 10 to 15 ms. Before a measurement takes place a number of dummy measuring cycles are carried out in order to bring about the dynamic state of equilibrium (SSFP state). The number of dummy measuring cycles is typically 64 to 128. The Field-Of-View (FOV) has a size of 48 mm×48 mm×48 mm or 32 mm×32 mm×32 mm, but it need not necessarily be of the same size in x, y and z.

The number of coding steps per spatial direction in this example are 8, 16 or 32 (not necessarily a multiple of 2, can differ in the spatial directions and the number in one direction can depend on the index in the other direction).

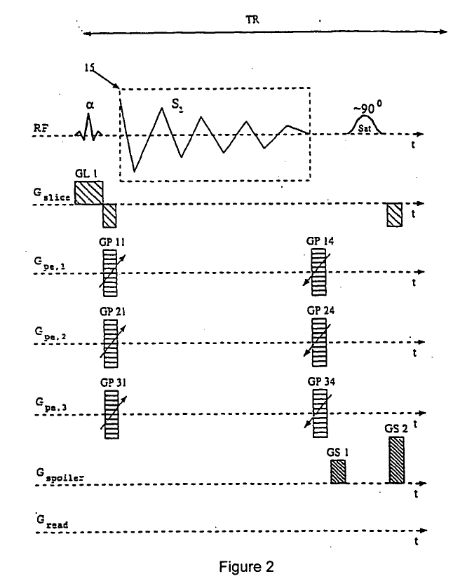

The excitation pulse and gradient graph shown in FIG. 2 belongs to a spectroscopic imaging method according to a further special embodiment of the invention, which is based on a Fourier Acquired Steady State (FAST) (also known as Fast Imaging with Study Precession (FISP) or GRAdient-Recalled Steady State (GRASS) and for details reference should be made to “Fast Field Echo Imaging: In Overview and Contrast Calculations”, P. von der Meulen, J. P. Groen, A. M. C. Tinus, G. Bruntink, Magnetic Resonance Imaging, vol. 6, pp 355 to 368, 1988)-SSFP sequence. Precisely as in the embodiment of FIG. 1, a layer-selective RF excitation pulse is irradiated with a flip angle onto a test object. Before the single readout window 15 the phase coding gradients GP11, GP21 and GP31 are switched for three-dimensional phase coding, the latter being cancelled out before the next RF excitation pulse (not shown) by the phase coding gradients GP14, GP24 and GP34.

The suppression of the echo-like SSFP signal S2 takes place by switching a first spoiler gradient GS1 after the readout window 15. Additionally, after the readout window 15 a second spoiler gradient GS2 is switched and between the first and second spoiler gradients GS1 and GS2 is irradiated a frequency-selective saturation pulse Sat for suppressing a water signal. The saturation pulse Sat is optional. If it is not provided the spoiler gradients GS1 and GS2 can also be combined for suppressing the SSFP echo S2. The reading out of the FID-like SSFP signal S1 in the single readout window 15 takes place without the presence of a magnetic field gradient.

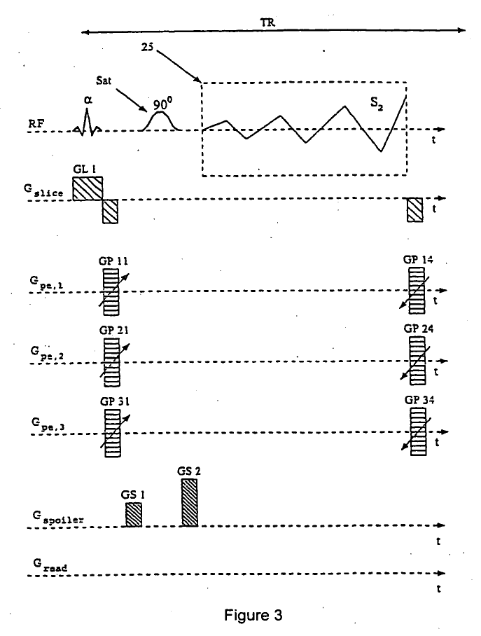

FIG. 3 shows an excitation pulse and gradient graph of a spectroscopic imaging method according to another special embodiment of the invention, which is based on a Contrast enhanced FAST (CE-FAST) or Time Reversed FISP(PSIF)-SSFP sequence.

Precisely as in the embodiments according to FIGS. 1 and 2, a layer-selective RF excitation pulse with a flip angle is irradiated onto a test object. Before the single readout window 25 a three-dimensional phase coding takes place, as in the embodiments according to FIGS. 1 and 2, and after readout window 25 is cancelled out again by switching the phase coding gradients GP14, GP24 and GP34. A first spoiler gradient GS1 is switched before the readout window 24 for suppressing the FID signal S1. Additionally, before readout window 25, a second spoiler gradient GS2 is switched and a frequency-selective saturation pulse Sat is irradiated between the first and second spoiler gradients GS1 and GS2 for suppressing a water signal. The reading out of the echo-like SSFP signal S2 in the single readout window 25 takes place without the presence of a magnetic field gradient.

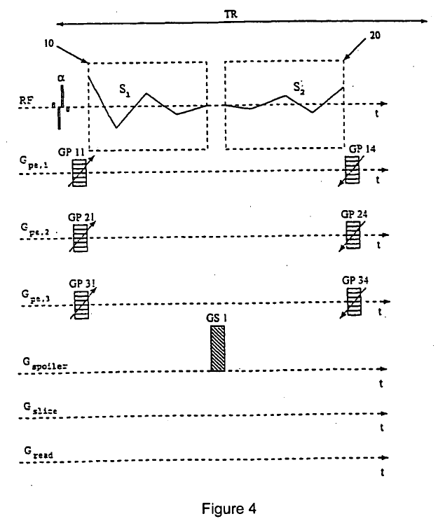

FIG. 4 shows an excitation pulse and gradient graph of a spectroscopic imaging method according to another special embodiment of the invention, which differs from that of FIG. 1 in that in place of a layer-selective RF excitation pulse there is a frequency-selective RF excitation pulse in the form of hard pulses, so that for 1H-NMR there is no need to suppress the water signal by means of a saturation pulse. Thus, for the separation of the two readout windows 10 and 20 it is only necessary to have a single spoiler gradient GS1. There is also no switching of the phase coding gradients GP12, GP22 and GP32, as well as GP31, GP23 and GP33.

As a result of the frequency-selective (chemical shift-selective) excitation/refocussing by an optimized group of hard RF excitation pulses, the metabolite signals are excited or refocussed, but not (or only slightly) the water signal. The repetition time TR typical for the magnetic field strength of B0=4.7 T used here for measurement on phantoms or on a rat brain is in the range 30 to 120 ms. Prior to the measurement a number of dummy measuring cycles are performed in order to bring about the dynamic state of equilibrium. The number of dummy measuring cycles is typically 64 to 128. The FOV has the dimensions 48 mm×48 mm×48 mm or 32 mm×32 mm×32 mm, but x, y and z need not necessarily be of the same size. The number of coding steps per spatial direction is 8, 16 or 32 (not necessarily a multiple of 2, can differ in the spatial directions and the number of directions can be dependent on the index in one or other direction).

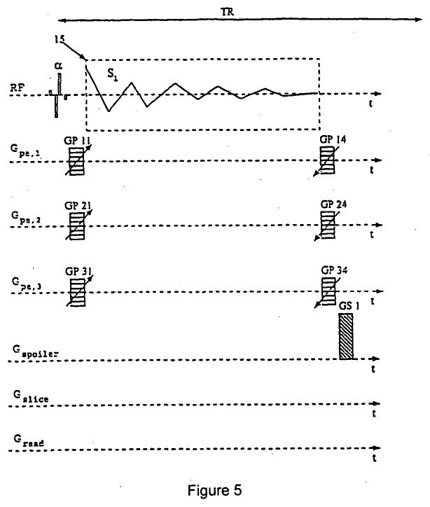

FIG. 5 is an excitation pulse and gradient graph of a spectroscopic imaging method according to another special embodiment of the invention, which differs from the embodiment according to FIG. 2 in that in place of a layer-selective RF excitation pulse use is made of a frequency-selective RF excitation pulse, so that there is no need for the irradiation of a saturation pulse and for spoiler gradient GS2. The suppression of the echo-like SSFP signal S2 takes place by switching the spoiler gradient GS1.

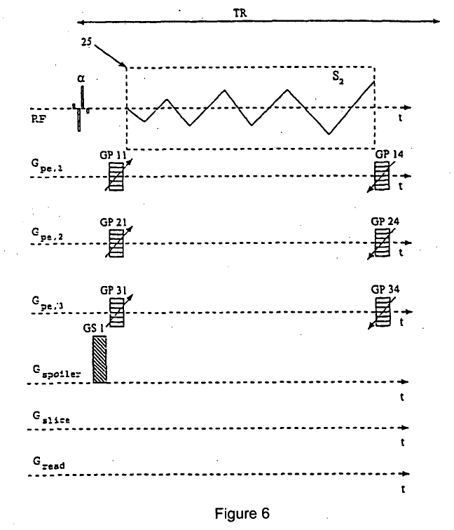

FIG. 6 shows an excitation pulse and gradient graph of a spectroscopic imaging method according to another special embodiment of the invention, which differs from the embodiment according to FIG. 3 in that in place of a layer-selective RF excitation pulse use is made of a frequency-selective RF excitation pulse in hard pulse form, so that there is no need for a saturation pulse Sat for suppressing a water signal and a spoiler gradient GS2. The suppression of the FID-like SSFP signal S1 takes place by switching the spoiler gradient GS1.

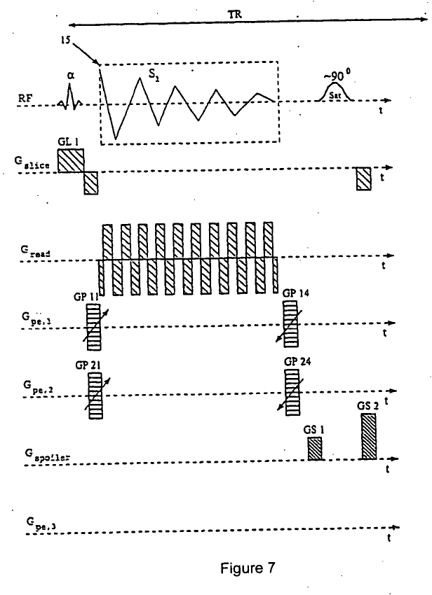

FIG. 7 is an excitation pulse and gradient graph of a spectroscopic imaging method according to another special embodiment of the invention, which differs from the embodiment according to FIG. 2 in that only two phase coding gradients GP11 and GP21 are switched before the readout window 15 and after the readout window 15 the phase coding gradients GP14 and GP24 are switched for cancelling out the phase coding.

The embodiment of FIG. 7 differs from the embodiment of FIG. 2 also in that the FID-like SSFP signal S1 in the measurement window 15 is read out under an oscillating readout gradient Gread. Together with the two-dimensional phase coding, this gives a three-dimensional resolution in a selected layer.

FIG. 8 shows the measured results of the spectroscopic imaging method according to FIG. 1 on a spherical phantom filled with 100 mM NAA. FIG. 8a shows the spectrum obtained through the evaluation of the FID-like SSFP signal S1, FIG. 8b the spectrum obtained by evaluating the echo-like SSFP signal S2 (TR=69 ms, 16×1.6 PE steps, Tmeasurement=17 s) and FIG. 8c the imaging of the CH3 signal of NM obtained by means of the echo-like SSFP signal S2 (TR=69 ms, 32×32 PE steps, Tmeasurement=68 s).

FIGS. 9a to 9c show exemplified computer simulations for “typical” parameters, i.e. the relaxation times T1=1.5 and T2=250 ms correspond to values normally exhibited by metabolites in the brain in the case of a measurement on a 4.7 Tesla tomograph. FIG. 9a shows the dependence of the SNRt (here S1/TR<< of the repetition time TR and flip or tilt angle for the SSFP signal S1). Correspondingly FIG. 9b shows the SNRt for the SSFP signal S2. FIG. 9c plots the S1/TR<< and S2/TR<< for a repetition time of 65 ms as a function of the flip angle and for comparison purposes the corresponding values for spectroscopic imaging in the prior art (at TR 65 ms and completely relaxed at TR=6 s). This shows that the statement made inter alia in the article by Pohmann et al (J. Mag. Reson. 129, 145-160, 1997) that the conventional spectroscopic imaging represents the “Gold standard” with regards to sensitivity, no longer applies if SSFP-based methods according to the special embodiments of the present invention are used, because they are not only advantageous with regards to the reduced overall measurement time, but also with regards to the SNRt compared with the conventional SI.

The lower minimum measurement times according to at least the special embodiments of the invention arise in that:
compared with the method described by Speck et al. at least many resonance lines can be simultaneously detected, so that compared with sequential detection it is possible to achieve a shorter minimum measurement time and also a higher signal-to-noise ratio,
compared with the sequences not based on SSFP for spectroscopic imaging, the inherently short repetition time TR of SSFP-based sequences leads to a short minimum measurement time and, due to the characteristics of SSFP sequences, still leads to a high signal-to-noise ratio.

The features of the invention disclosed in the description, drawings and claims can both singly and in random combinations, be essential to the implementation of the different embodiments of the invention.

### LIST OF REFERENCE NUMERALS

10 First readout window
15 Readout window
20 Second readout window
25 Readout window

We claim as our invention:

1-54. (canceled)

55. A spectroscopic imaging method using an SSFP-RF excitation pulse sequence, comprising the steps of:
with a repetition time TR, irradiating RF excitation pulses, each having a flip angle, into a subject;
between said RF excitation pulses, in a first read-out window without a magnetic field gradient, reading out an FID-like SSFP signal S1, and in a second readout window separate from said first readout window and without a magnetic gradient field, reading out an echo-like SSFP signal S2;
before said readout window, activating at least one phase coding gradient that phase codes said subject in at least one spatial direction; and
before a next RF excitation pulse, activating at least one further phase coding gradient that cancels said phase coding gradient in said at least one spatial direction.

56. A method as claimed in claim 55 comprising separating said first and second readout windows by activating a spoiler gradient between said signals S1 and S2.

57. A method as claimed in claim 55 comprising slice-selectively irradiating said subject with said RF excitation pulses.

58. A method as claimed in claim 57 comprising separating said first and second readout windows by activating first and second spoiler gradients between said signals S1 and S2, and irradiating said subject with a frequency-selective RF saturation pulse between said first and second spoiler gradients.

59. A method as claimed in claim 55 comprising activating said at least one further phase coding gradient after said first readout window and before said second readout window, and activating another phase coding gradient, between said at least one further phase coding gradient and said second readout window, for phase coding said subject in at least one spatial direction.

60. A method as claimed in claim 55 comprising frequency-selectively irradiating said RF excitation pulses.

61. A method as claimed in claim 55 comprising before said second readout window, activating exactly two phase coding gradients to phase code said subject respectively in two spatial directions, and before said next RF excitation pulse, activating exactly two further phase coding gradients to respectively cancel said phase coding in said two spatial directions.

62. A method as claimed in claim 55 comprising before said second readout window, activating exactly two phase coding gradients to phase code said subject respectively in three spatial directions, and before said next RF excitation pulse, activating exactly three further phase coding gradients to respectively cancel said phase coding in said three spatial directions.

63. A method as claimed in claim 55 comprising activating said at least one further phase coding gradient after said first readout window and before said second readout window, and activating another phase coding gradient, between said at least one further phase coding gradient and said second readout window, for phase coding said subject in at least one spatial direction, comprising before said second readout window, activating exactly two phase coding gradients to phase code said subject respectively in two spatial directions, and before said next RF excitation pulse, activating exactly two further phase coding gradients to respectively cancel said phase coding in said two spatial directions.

64. A method as claimed in claim 55 comprising activating said at least one further phase coding gradient after said first readout window and before said second readout window, and activating another phase coding gradient, between said at least one further phase coding gradient and said second readout window, for phase coding said subject in at least one spatial direction, comprising before said second readout window, activating exactly three phase coding gradients to phase code said subject respectively in three spatial directions, and before said next RF excitation pulse, activating exactly three further phase coding gradients to respectively cancel said phase coding in said three spatial directions.

65. A method as claimed in claim 55 comprising detecting said signals S1 and S2 with a single RF coil.

66. A method as claimed in claim 55 comprising detecting said signal S1 with a first RF coil having a first spatial sensitivity profile, and detecting said signal S2 with a second RF coil having a second spatial sensitivity profile, different from said first spatial sensitivity profile.

67. A spectroscopic imaging method using an SSFP-RF excitation pulse sequence, comprising the steps of:
with a repetition time TR, irradiating a subject with RF excitation pulses, each having a flip angle;
between said RF excitation pulses, in a single readout window without a magnetic field gradient, reading out a single FID-like SSFP signal;
before said readout window, activating at least one phase coding gradient to phase code said subject in at least one spatial direction; and
before a next RF excitation pulse, activating at least one further phase code gradient to cancel said phase coding in said at least one spatial direction.

68. A method as claimed in claim 67 comprising after said readout window, activating a spoiler gradient.

69. A method as claimed in claim 67 comprising slice/selectively irradiating said subject with said RF excitation pulses.

70. A method as claimed in claim 69 comprising after said readout window, activating first and second spoiler gradients, and between said first and second spoiler gradients, irradiating said subject with a frequency selective RF saturation pulse.

71. A method as claimed in claim 67 comprising frequency-selectively irradiating said subject with said RF excitation pulses.

72. A method as claimed in claim 67 comprising before said readout window, activating a spoiler gradient.

73. A method as claimed in claim 67 comprising, before said readout window, activating first and second spoiler gradients, and between said first and second spoiler gradients, irradiating said subject with a frequency-selective RF saturation pulse.

74. A method as claimed in claim 67 comprising before said second readout window, activating exactly two phase coding gradients to phase code said subject respectively in two spatial directions, and before said next RF excitation pulse, activating exactly two further phase coding gradients to respectively cancel said phase coding in said two spatial directions.

75. A method as claimed in claim 67 comprising before said second readout window, activating exactly two phase coding gradients to phase code said subject respectively in three spatial directions, and before said next RF excitation pulse, activating exactly three further phase coding gradients to respectively cancel said phase coding in said three spatial directions.

76. A method as claimed in claim 67 comprising detecting said signals S1 and S2 with a single RF coil.

77. A method as claimed in claim 67 comprising detecting said signal S1 with a first RF coil having a first spatial sensitivity profile, and detecting said signal S2 with a second RF coil having a second spatial sensitivity profile, different from said first spatial sensitivity profile.

78. A spectroscopic imaging method using an SSFP-RF excitation pulse sequence, comprising the steps of:
with a repetition time TR, irradiating a subject with RF excitation pulses, each having a flip angle;
before said RF excitation pulses, and in a single readout window without a magnetic field gradient, reading out a single echo-like SSFP signal;
before said readout window, activating at least one phase coding gradient to phase code said subject in at least one spatial direction; and
before a next RF excitation pulse, activating at least one further phase coding gradient to cancel said phase coding in said at least one spatial direction.

79. A method as claimed in claim 78 comprising before said second readout window, activating exactly two phase coding gradients to phase code said subject respectively in two spatial directions, and before said next RF excitation pulse, activating exactly two further phase coding gradients to respectively cancel said phase coding in said two spatial directions.

80. A method as claimed in claim 78 comprising before said second readout window, activating exactly two phase coding gradients to phase code said subject respectively in three spatial directions, and before said next RF excitation pulse, activating exactly three further phase coding gradients to respectively cancel said phase coding in said three spatial directions.

81. A method as claimed in claim 78 comprising detecting said signals S1 and S2 with a single RF coil.

82. A method as claimed in claim 78 comprising detecting said signal S1 with a first RF coil having a first spatial sensitivity profile, and detecting said signal S2 with a second RF coil having a second spatial sensitivity profile, different from said first spatial sensitivity profile.

83. A spectroscopic imaging method using an SSFP-RF excitation pulse sequence, comprising the steps of:
with a repetition time, irradiating a subject with RF excitation pulses, each having a flip angle;
between said RF excitation pulses, in a first readout window occurring simultaneously with at least one readout gradient alternating in a spatial direction, reading out an FID-like SSFP signal S1 and, in a second readout window separate from said first readout window, occurring simultaneously with at least one further readout gradient alternating in a spatial direction, reading out an echo-like SSFP signal S2.

84. A method as claimed in claim 83 comprising activating a single readout gradient alternating in a spatial direction in both of said first and second window and, before said readout window, activating at least one phase coding gradient to phase code said subject in at least one spatial direction, and before next RF excitation pulse, activating at least one further phase coding gradient to cancel said phase coding in said at least one spatial direction.

85. A method as claimed in claim 83 comprising activating a first readout gradient alternating in a first spatial direction in said first window and reading out said signal S1 under said first readout gradient, and activating a second readout gradient during said second window, alternating in a second spatial direction, different from said first spatial direction, and reading out said signal S2 under said second readout gradient, and before said first readout window activating a single phase coding gradient to phase code said subject in a spatial direction, and before a next RF excitation pulse, activating a single further phase coding gradient to cancel said phase coding in said spatial direction.

86. A method as claimed in claim 83 comprising, in each of said first and second windows, activating exactly three readout gradients, respectively alternating in three different spatial directions, and reading out each of said signal S1 and said signal S2 under said three readout gradients.

87. A method as claimed in claim 83 comprising separating said first and second readout windows by activating a spoiler gradient between said signals S1 and S2.

88. A method as claimed in claim 83 comprising slice/selectively irradiating said subject with said RF excitation pulses.

89. A method as claimed in claim 88 comprising activating first and second spoiler gradients between said signals S1 and S2, and irradiating said subject with a frequency-selected RF saturation pulse between said first and second spoiler gradients.

90. A method as claimed in claim 88 comprising, before said first readout window, activating a phase coding gradient to phase code said subject in a spatial direction, and after said first readout window and before said second readout window, activating a further phase coding gradient to cancel said phase coding in said spatial direction, and activating another phase coding gradient to phase code said subject in a spatial direction.

91. A method as claimed in claim 83 comprising frequency-selectively irradiating said subject with said RF excitation pulses.

92. A method as claimed in claim 83 comprising detecting said signals S1 and S2 with a single RF coil.

93. A method as claimed in claim 83 comprising detecting said signal S1 with a first RF coil having a first spatial sensitivity profile, and detecting said signal S2 with a second RF coil having a second spatial sensitivity profile, different from said first spatial sensitivity profile.

94. A spectroscopic imaging method using an SSFP-RF excitation pulse sequence, comprising the steps of:
with a repetition time TR, irradiating a subject with RF excitation pulses, each having a flip angle; and
between said RF excitation pulses, activating at least one readout gradient in a single readout window, said at least one readout gradient oscillating in a spatial direction, and reading out a single FID-like SSFP signal.

95. A method as claimed in claim 94 comprising activating a single readout gradient oscillating in a spatial direction and reading out said FID-like SSFP signal under said single readout gradient, and before said readout window activating at least one phase coding gradient to phase code said subject in at least one spatial direction, and before a next RF excitation pulse, activating at least one further phase coding gradient to cancel said phase coding gradient in said at least one spatial direction.

96. A method as claimed in claim 94 comprising activating, in said readout window, only a first readout gradient alternating in a first spatial direction and a second readout gradient alternating in a second spatial direction, differing from said first spatial direction, and reading out said FID-like SSFP signal under both of said first and second readout gradients, and before said readout window activating a single phase coding gradient to phase code said subject in one spatial direction, and before a next RF excitation pulse, activating a single further phase coding gradient to cancel said phase coding in said one spatial direction.

97. A method as claimed in claim 94 comprising, in said readout window, activating exactly three readout gradients respectively alternating in three different spatial directions, and reading out said FID-like SSFP signal under all of said three readout gradients.

98. A method as claimed in claim 94 comprising activating a spoiler gradient after said readout window.

99. An imaging method as claimed in claim 94 comprising slice/selectively irradiating said subject with said RF excitation pulses.

100. A method as claimed in claim 99 comprising activating first and second spoiler gradients after said readout window and, between said first and second spoiler gradients, irradiating said subject with a frequency-selective RF saturation pulse.

101. A method as claimed in claim 94 comprising frequency-selectively irradiating said subject with said RF excitation pulses.

102. A method as claimed in claim 94 comprising detecting said signals S1 and S2 with a single RF coil.

103. A method as claimed in claim 94 comprising detecting said signal S1 with a first RF coil having a first spatial sensitivity profile, and detecting said signal S2 with a second RF coil having a second spatial sensitivity profile, different from said first spatial sensitivity profile.

104. A spectroscopic imaging method using an SSFP-RF excitation pulse sequence, comprising the steps of:
with a repetition time TR, irradiating a subject with RF excitation pulses, each having a flip angle; and
between said RF excitation pulses, activating at least one readout gradient in a single readout window, said at least one readout gradient oscillating in a spatial direction, and reading out a single echo-like SSFP signal.

105. A method as claimed in claim 94 comprising activating a single readout gradient oscillating in a spatial direction and reading out said echo-like SSFP signal under said single readout gradient, and before said readout window activating at least one phase coding gradient to phase code said subject in at least one spatial direction, and before a next RF excitation pulse, activating at least one further phase coding gradient to cancel said phase coding gradient in said at least one spatial direction.

106. A method as claimed in claim 94 comprising activating, in said readout window, only a first readout gradient alternating in a first spatial direction and a second readout gradient alternating in a second spatial direction, differing from said first spatial direction, and reading out said echo-like SSFP signal under both of said first and second readout gradients, and before said readout window activating a single phase coding gradient to phase code said subject in one spatial direction, and before a next RF excitation pulse, activating a single further phase coding gradient to cancel said phase coding in said one spatial direction.

107. A method as claimed in claim 94 comprising, in said readout window, activating exactly three readout gradients respectively alternating in three different spatial directions, and reading out said echo-like SSFP signal under all of said three readout gradients.

108. A method as claimed in claim 104 comprising activating a spoiler gradient after said readout window.

109. An imaging method as claimed in claim 104 comprising slice/selectively irradiating said subject with said RF excitation pulses.

110. A method as claimed in claim 94 comprising activating first and second spoiler gradients after said readout window and, between said first and second spoiler gradients, irradiating said subject with a frequency-selective RF saturation pulse.

111. A method as claimed in claim 104 comprising frequency-selectively irradiating said subject with said RF excitation pulses.

112. A method as claimed in claim 104 comprising detecting said signals S1 and S2 with a single RF coil.

113. A method as claimed in claim 104 comprising detecting said signal S1 with a first RF coil having a first spatial sensitivity profile, and detecting said signal S2 with a second RF coil having a second spatial sensitivity profile, different from said first spatial sensitivity profile.

114. A magnetic resonance spectroscopy apparatus comprising:
a radio frequency resonator arrangement and a gradient coil system; and
a control unit for operating said magnetic resonance scanner to, with a repetition time, irradiate the subject with RF excitation pulses emitted from said RF resonator arrangement, each of said RF excitation pulses having a flip angle, and, between said RF excitation pulses, in a first readout window without a magnetic field gradient, readout an FID-like SSFP signal S1 and, in a second readout window separate from said first readout window and without a magnetic field gradient, to readout an echo-like SSFP signal S2, and to activate, before said first readout window, at least one phase coding gradient emitted by said gradient coil system to phase code the subject in at least one spatial direction, and to activate at least one further phase coding gradient emitted by said gradient coil system to cancel said phase coding in said at least one spatial direction.

115. A magnetic resonance spectroscopy apparatus comprising:
a radio frequency resonator arrangement and a gradient coil system;
a control unit for operating said magnetic resonance scanner to, with a repetition time, irradiate the subject with RF excitation pulses, emitted from said RF resonator arrangement, each having a flip angle, and, between said RF excitation pulses, in a single readout window without a magnetic field gradient, to readout a single FID-like SSFP signal, and before said readout window to activate at least one phase coding gradient, emitted by said gradient coil system, to phase code said subject in at least one spatial direction and, before a next RF excitation pulse, to activate at least one further phase coding gradient, emitted by said gradient coil system, to cancel said phase coding in said at least one spatial direction.

116. A magnetic resonance spectroscopy apparatus comprising:
a radio frequency resonator arrangement and a gradient coil system;
a control unit for operating said magnetic resonance scanner to, with a repetition time, irradiate the subject with RF excitation pulses, emitted from said RF resonator arrangement, each having a flip angle, and, between said RF excitation pulses, in a single readout window without a magnetic field gradient, to readout a single echo-like SSFP signal, and before said readout window to activate at least one phase coding gradient, emitted by said gradient coil system, to phase code said subject in at least one spatial direction and, before a next RF excitation pulse, to activate at least one further phase coding gradient, emitted by said gradient coil system, to cancel said phase coding in said at least one spatial direction.

117. A magnetic resonance spectroscopy apparatus comprising:
a radio frequency resonator arrangement and a gradient coil system;
a control unit for operating said magnetic resonance scanner to, with a repetition time, irradiate said subject with RF excitation pulses, emitted from said RF resonator arrangement, each having a flip angle, and, between said RF excitation pulses, in a first readout window, to activate at least one readout gradient, emitted from said gradient coil system, alternating in one spatial direction, to readout an FID-like SSFP signal S1 and, in a second readout window separate from said first readout window, to activate at least one readout gradient alternating in one spatial direction, to readout an echo-like SSFP signal.

118. A magnetic resonance spectroscopy apparatus comprising:
a radio frequency resonator arrangement and a gradient coil system;
a control unit for operating said magnetic resonance scanner to, with a repetition time, irradiate said subject with RF excitation pulses, emitted from said RF resonator arrangement, each having a flip angle and, between said RF excitation pulses, in a single readout window, to activate at least one readout gradient alternating in one spatial direction, to readout a single FID-like signal.

119. A magnetic resonance spectroscopy apparatus comprising:
a radio frequency resonator arrangement and a gradient coil system;
a control unit for operating said magnetic resonance scanner to, with a repetition time, irradiate said subject with RF excitation pulses, emitted from said RF resonator arrangement, each having a flip angle and, between said RF excitation pulses, in a single readout window, to activate at least one readout gradient alternating in one spatial direction, to readout a single echo-like signal.
